(19) United States
(12) Patent Application Publication
(10) Pub. No.: US 2026/0327447 A1
(43) Pub. Date: Oct. 22, 2026

(54) COMPOSITIONS FOR PRODUCING MATT-GLOSS INKJET INKS AND USE THEREOF IN INKJET PRINTING PROCESSES

(71) Applicant: MANKIEWICZ GEBR. & CO. (GMBH & CO. KG), HAMBURG (DE)

(72) Inventors: CIHAN KOESE, STUTTGART (DE); UMBERTO DE ROSSI, NORDERSTEDT (DE); OLIVER BOLENDER, HAMBURG (DE)

(73) Assignee: MANKIEWICZ GEBR. & CO. (GMBH & CO. KG), HAMBURG (DE)

(21) Appl. No.: 19/111,323

(22) PCT Filed: Sep. 13, 2023
(86) PCT No.: PCT/DE2023/100687

§ 371 Date: Mar. 13, 2025

(30) Foreign Application Priority Data
Sep. 15, 2022 (DE) 10 2022 123 666.8

(51) Int. Cl. C09D 11/38; C09D 11/54

(52) U.S. Cl. CPC C09D 11/38; C09D 11/54

(57) ABSTRACT

A coating material composition for producing a matte ink. The coating composition includes 10 to bis 40 wt. % of at least one difunctional monomer, 20 to 50 wt. % of at least one monofunctional monomer, 5 to 35 wt. % of at least one organic matting agent which is selected from at least one polymethyl urea powder having a particle size of D90<1 μm, 1 to 30 wt. % of at least one acrylate oligomer or at least one polyfunctional acrylate monomer or a mixture of the at least one acrylate oligomer and the at least one polyfunctional acrylate monomer, and 2 to 13 wt. % of at least one photoinitiator. Each wt. % is based on a total weight of the coating material composition.

### CROSS REFERENCE TO PRIOR APPLICATIONS

This application is a U.S. National Phase application under 35 U.S.C. § 371 of International Application No. PCT/DE2023/100687, filed on Sep. 13, 2023 and which claims benefit to German Patent Application No. 10 2022 123 666.8 filed on Sep. 15, 2022. The International Application was published in German on Mar. 21, 2024 as WO 2024/056135 A1 under PCT Article 21 (2).

### FIELD

The present invention relates to digitally applicable, UV-curing coating materials which produce matte coatings. The present invention in particular relates to UV-curing inks which can be applied via inkjet printing methods. The present invention further relates to coating systems in which the coating materials, in particular the inkjet inks, are used for producing a top coat layer or a finishing coat.

### BACKGROUND

Decorative, colored coatings are generally produced via digital printing methods, primarily via inkjet printing methods. The term “inkjet printing method” is defined hereafter as a contactless, direct, non-impact printing process without a printing form, which is based on electronic principles. In this method, in accordance with the electronic instructions of a computer, a suitable coating material is pressed through a microscopically fine nozzle and is then directed, by electrostatic or magnetic fields, to the substrate to be printed in order to there generate a text or image(s).

It has to date not been possible, however, to produce matte surfaces via digital printing process because the usual matte lacquers cannot be employed in these processes. In order to nevertheless obtain a matte printing, the matte lacquers must be applied subsequent to the inkjet printing in an additional process step via suitable methods, i.e., spray application with subsequent oven drying. These additional process steps lead to an increased expenditure of work and time for the printing process.

### SUMMARY

An aspect of the present invention is to provide improved coating material compositions, in particular inkjet inks and coating systems, with which matte surfaces can be produced via the usual inkjet printing methods.

In an embodiment, the present invention provides a coating material composition for producing a matte ink. The coating composition includes 10 to bis 40 wt. % of at least one difunctional monomer, 20 to 50 wt. % of at least one monofunctional monomer, 5 to 35 wt. % of at least one organic matting agent which is selected from at least one polymethyl urea powder having a particle size of D90<1 μm, 1 to 30 wt. % of at least one acrylate oligomer or at least one polyfunctional acrylate monomer or a mixture of the at least one acrylate oligomer and the at least one polyfunctional acrylate monomer, and 2 to 13 wt. % of at least one photoinitiator. Each wt. % is based on a total weight of the coating material composition.

### DETAILED DESCRIPTION

The compositions according to the present invention contain at least:
10 to 40% by weight of one or more difunctional monomers,
20 to 50% by weight of one or more monofunctional monomers,
5 to 35% by weight of one or more organic matting agents,
1 to 30% by weight of one or more acrylate oligomers or one or more polyfunctional acrylate monomers or mixtures of one or more acrylate oligomers and one or more polyfunctional acrylate monomers, and
2 to 13% by weight of one or more photoinitiators,
the percentages by weight being based in each case on the total weight of the composition.

The compositions can, for example, contain:
10 to 40% by weight, for example, 15 to 35% by weight, of one or more difunctional monomers,
20 to 45% by weight, for example, 20 to 42% by weight, of one more monofunctional monomers,
5 to 25% by weight, for example, 5 to 20% by weight, of one more organic matting agents,
5 to 30% by weight, for example, 10 to 30% by weight, of one or more acrylate oligomers or one or more polyfunctional acrylate monomers or mixtures of one or more acrylate oligomers and one or more polyfunctional acrylate monomers, and
4 to 11% by weight, for example, 6 to 9% by weight, of one or more photoinitiators,
the percentages by weight being based in each case on the total weight of the composition.

The term “matting agents” is defined hereafter as additives and auxiliary agents which reduce the gloss of a coating or which produce a matte finish. Matting agents are used to achieve a scattering of the light at the surface of the coating, which is obtained by application and curing of coating materials.

Suitable matting agents according to the present invention are organic matting agents on the basis of polymer powders having a particle size of D90<2 μm. That means that 90% of the particles exhibit particle diameters of less than 2 μm. Polymer powders having a particle size of D90<1 μm can, for example, be provided. That means that 90% of the particles exhibit particle diameters of less than 1 μm. Polymethyl urea powders can, for example, be used. In a further embodiment, the polymethyl urea powders are predispersed in diacrylates.

Suitable difunctional monomers according to the present invention are 1,6-hexandiol diacrylate, 3-methyl-1,5-pentanediol diacrylate, 1,4-butandiol acrylate, propoxylated neopentyl glycol diacrylate, tripropylene glycol diacrylate, dipropylene glycol diacrylate, tetraethylene glycol diacrylate, and mixtures thereof. 1,6-hexanediol diacrylate, 3-methyl-1,5-pentanediol diacrylate, tripropylene glycol diacrylate, and mixtures thereof, can, for example, be used.

Suitable monofunctional monomers according to the present invention are isodecyl acrylate, lauryl acrylate, octyl decyl acrylate, isobornyl acrylate, 4-tert-butylcyclohexyl acrylate, trimethylcyclohexyl acrylate, trimethylolpropane formal acrylate, and mixtures thereof. Isodecyl acrylate, lauryl acrylate, and mixtures thereof, can, for example, be used.

Suitable acrylate oligomers according to the present invention are amine-modified acrylate oligomers, urethane acrylate oligomers, hyperbranched acrylate oligomers, and mixtures thereof. Mixtures of amine-modified acrylate oligomers and urethane acrylate oligomers can, for example, be used. Suitable polyfunctional acrylate monomers are monomers with at least four functional groups.

Suitable photoinitiators are methylbenzoyl format (available, for example, under the trade name Genocure® MBF), 2-hydroxy-2-methyl-1-phenylpropane (available, for example, under the trade name Omnirad® 1173), 1-hydroxycyclohexyl phenyl ketone (available, for example, under the trade name Omnirad® 184), 2-hydroxy-1-(4-(4-(2-hydroxy-2-methylpropionyl)benzyl)phenyl)-2-methylpropane-1-one (available, for example, under the trade name Omnirad® 127), 2-hydroxy-1-(4-(4-(2-hydroxy-2-methyl-propionyl) phenoxy)phenyl)-2-methylpropan-1-one (available, for example, under the trade name Esacure® KIP 160), difunctional ketosulfones such as, for example, 1-(4-[(4-benzoylphenyl)thio]phenyl)-2-methyl-2-[(4-methylphenyl) sulfonyl]-1-propan-1-one (available, for example, under the trade name Esacure® 1001M), bis(2,4,6-trimethyl-benzoyl)phenylphosphine oxide (available, for example, under the trade name Omnirad® 819), ethyl-(2,4,6-trimethylbenzoyl)phenylphosphinate (available, for example, under the trade name Omnirad® TPO-L), 2,4,6-trimethylbenzoyldiphenylphosphine oxide (available, for example, under the trade name Genocure® TPO), 2,4-diethylthioxanthone (available, for example, under the trade name Genocure® DETX), isopropylthioxanthone (available, for example, under the trade name Genocure® ITX), 1-chloro-4-propoxythioxanthone (available, for example, under the trade name Omnirad® CPTX), polymeric ethyl-(2,4,6-trimethylbenzoyl)phenyl phosphinate (available, for example, under the trade name Omnipol® TP) and mixtures thereof. Bis(2,4,6-trimethylbenzoyl)phenylphosphine oxide, ethyl-(2,4,6-trimethylbenzoyl)phenylphosphinate, 2,4,6-trimethylbenzoyldiphenylphosphine oxide, 2-hydroxy-2-methyl-1-phenylpropane, 1-hydroxy-cyclohexylphenyl ketone, and mixtures thereof can, for example, be used.

In a further embodiment, the composition according to the present invention can, for example, contain 0.1 to 1.3% by weight, for example, 0.3 to 1.0% by weight, for example, 0.4 to 0.8% by weight, in each case based on the total weight of the composition, of one or more stabilizers to avoid polymerization during storage. Suitable stabilizers are methoxyphenol, butylhydroxytoluene, 2,6-bis(1,1-dimethylethyl)-4-(phenylene-methylene)-cyclohexa-2,5-dien-1-one, tris(N-hydroxy-N-nitrosophenylaminato-O,O′)aluminum, and mixtures thereof, dissolved in radiation-curable resins or in acrylic acid esters (for example, commercially available products under the trade names Genorad® 16, Genorad® 22, Genorad® 23, Genorad® 24, Genorad® 26 and Irgastab® UV 22).

In a further embodiment, the composition according to the present invention can, for example, contain 0.1 to 1.0% by weight, for example, 0.2 to 0.8% by weight, for example, 0.3 to 0.6% by weight, in each case based on the total weight of the composition, of one or more levelling agents to reduce the surface tension. Suitable levelling agents are organically modified silicones such as silicone polyethers and silicone acrylates (for example, commercially available products with the trade names Tego® Rad 2200 N, Tego® Rad 2300, Tego® Glide 432, Efka® SL 3299, Byk® UV 3500, Byk® UV 3510 and Byk® 377).

The compositions according to the present invention may also contain customary additives and auxiliary agents which are familiar to the person skilled in the art.

The compositions according to the present invention produce matte coatings with a degree of gloss between 8 and 60 GU at a measurement angle of 60°. The coatings produced until now via inkjet printing methods exhibit a degree of gloss in the range from 60 to 90 GU at a measurement angle of 60°. The term “gloss” is defined hereafter as the optical property of a surface to reflect light specularly in whole or in part. The degree of gloss is expressed as the quotient of the specularly reflected part and the diffusely reflected part of a luminous flux falling on a surface. Specular gloss exhibits a diffusely reflected part close to zero, ideally zero. In contrast thereto, mattness exhibits a part of specularly reflected light close to zero, ideally of zero. The gloss of surface coatings such as layers of colors and paints are usually determined via a reflectometer or glossmeter. For this purpose, directed light is irradiated onto the sample surface at a defined angle. At the same angle, a detector measures the luminous radiation reflected from the sample surface. The results thereby obtained are indicated in gloss units GU. The measurement angle is selected depending upon the material and the expected gloss so that the sensitivity of the detector is utilized as well as possible. Measuring is normally effected at angles of 20°, 60° and 85° in order to obtain values which are as precise as possible.

It has been found that adding a matting agent alone does not show any significant reduction of the gloss of the cured coating surface. Only the combination of matting agents, monomers, oligomers and photoinitiators according to the present invention provides digitally printable coating materials which develop coatings with a matte surface. Due to the combination of polar particles of the matting agent and nonpolar monomers of the binder according to the present invention, the particles of the matting agent accumulate in the surface of the applied, wet layer. This accumulation is promoted by a low viscosity of the composition. It has been found, however, that a too low viscosity of the composition leads to a separation of the particles already prior to application, which makes the application or printing even more difficult.

In an embodiment, the compositions according to the present invention can, for example, have viscosities in the range from 5 to 15 mPa*s at 45° C. and 1000/s, for example, 5 to 12 mPa*s at 45° C. and 1000/s, for example, 5 to 8 mPa*s at 45° C. and 1000/s. The viscosities have been determined via the Rheostress 600 device of the company Haake with the following parameters: measuring geometry plate-cone, temperature 45° C., shear rate 1000/s.

In a further embodiment, the compositions according to the present invention can be used as inks for producing matte coatings in inkjet printing processes because they meet the requirements of inkjet inks. In addition to the required viscosity, the compositions according to the present invention exhibit solid particles being small enough to fit through the nozzles of the printheads. The inks also exhibit a curing behavior generating error-free printing images during the very rapid inkjet printing processes. The inks according to the present invention can therefore readily be applied by commercially available inkjet printheads, for example, of the company Konica Minolta.

The compositions according to the present invention, in particular the inkjet inks according to the present invention, may be used for printing on substrates, such as, for example, glass, ceramic, plastic such as ABS-PC (acrylonitrile-butadiene-styrene copolymers in combination with polycarbonate) and polystyrene, wood, paper and cardboard. They can, for example, be used for printing on glass, furniture, toys and packaging such as, for example, corrugated cardboard packaging.

In an embodiment of the present invention, the inkjet inks can, for example, be employed for the production of matte top coatings, in particular as top coats in coating systems. The terms “top coating” or “top coat” are defined hereafter as the uppermost layer of a coating system which protects the subjacent layers against mechanical and chemical damage.

A further embodiment of the present invention provides coating systems exhibiting at least one decorative layer prepared from one or more colored inks and a top coat layer prepared from one or more matte inks according to the present invention.

In order to produce a decorative layer, UV-curing colored inks are employed which are suitable for the inkjet printing process. The colored inks can, for example, contain pigments, oligomers, photoinitiators, and reactive diluents. The colored inks may also contain further additives known and familiar to the person skilled in the art.

In order to improve the print image, the coating systems according to the present invention may contain, under the colored ink layer, an additional ink layer prepared from UV-curing inks, which contain bright, for example, white color pigments. The inks customary in color printing are subsequently applied to this white ink layer. The colors Cyan, Magenta, Yellow and Black, which are used in four-color printing (CMYK inks), can, for example, be used.

In a further embodiment, the coating systems according to the present invention further comprise a primer layer. As is known and familiar to the person skilled in the art, this primer layer is prepared from one or more primer coating materials. It forms the lowermost layer of the coating system. This means that the primer layer is the first layer being applied to the substrate. If required, the white ink layer is subsequently applied, followed by the decorative layer, and the top coat layer as the uppermost layer.

The present invention further relates to a method for producing the coating system according to the present invention which comprises the following steps:
(a) applying one or more colored inks via inkjet printing methods,
(b) pre-gelling the applied colored inks by UV irradiation,
(c) applying one or more matte inks via inkjet printing methods, and
(d) curing the entire layer construction by UV irradiation.

In a further embodiment, the matte ink or the matte inks applied in step (c) may be pre-gelled by UV irradiation in a further step (c1) prior to curing the entire layer construction in step (d). The additional pre-gelling of the matt ink layer enhances the mattness of the surface obtained.

In the last step (d), the entire layer construction consisting of pre-gelled decorative layer and top coat layer is completely cured by irradiation with rays or light in the wavelength range between 450 and 180 nm. Medium pressure mercury lamps with a power of 200 to 500 W/cm and LED lamps with a power of 10 to 30 W/cm² can, for example, be used therefor. The radiation dose thereby used can, for example, be in the range between 500 and 2000 mJ/cm².

In a further embodiment of the method, the steps (a) and (b) can, for example, initially be carried out by the use of white inks, with the steps then being repeated by the use of colored inks. A bright, for example, a white, ink layer is thereby generated onto which the actual image or decoration is printed. A significantly improved print image is obtained as a result of the white underlayment, in particular on colored or dark substrate surfaces.

An ink is usually completely cured by UV light or UV irradiation subsequent to its application to a substrate in order to form a coating. In order to improve adhesion within a coating system that contains several successive layers, the layers are initially cured or pre-gelled only to such an extent that they no longer run. This process step is referred to hereafter as “pinning”. The terms “pre-gelling” or “pinning” are defined hereafter as fixing a coating material through pre-reaction. The coating material is pre-gelled. This means that it is pre-cured to such an extent that it is no longer liquid. It already forms a sufficiently solid coating which, however, is not yet entirely cured. LED radiators emitting radiation in a wavelength range of 385 to 395 nm can, for example, be used as a radiation source for pre-gelling or pinning. The power lies between 2 to 5 W. Radiation with a dose of 20 to 100 mJ/cm² can, for example, be used.

The entire layer construction is completely cured in the last step. During this final curing of all printed and pre-gelled layers, the coatings cross-link so that very stable layer constructions are formed.

In an embodiment of the method according to the present invention, the process parameters can, for example, be specified so that a surface structure is formed. The formation of grid structures can, for example, be used. In a further embodiment, the matte inks can, for example, be applied with a layer thickness in the range from 3 to 60 μm.

The method according to the present invention can be performed by commercially available inkjet printers in printing processes known and familiar to the person skilled in the art, such as flatbed printing, direct-to-shape printing (cylindrical or non-cylindrical), single-pass printing, and multi-pass printing.

In order to improve chemical and mechanical bonding of the coatings, the substrate surfaces can be pre-treated via the methods known and familiar to the person skilled in the art. In a further embodiment, a primer layer is initially applied to the substrate surface in order to improve adhesion to the substrate surface. Suitable primer coating materials are known and familiar to the person skilled in the art. The primer layer can be applied via both inkjet printing methods and conventional printing and varnishing methods.

### EXAMPLE

### Compositions Matte Inks

### Example 1

| Constituent | Content/[% by weight] |
|---|---|
| difunctional acrylate monomers | 35 |
| monofunctional acrylate monomers | 35 |
| polymethyl urea powder | 5 |
| polyfunctional acrylate monomers | 12 |
| acrylate oligomers | 6 |
| photoinitiators | 7 |

### Example 2

| Constituent | Content/[% by weight] |
|---|---|
| difunctional acrylate monomers | 30 |
| monofunctional acrylate monomers | 42 |
| polymethyl urea powder | 10 |
| polyfunctional acrylate monomers | 5 |
| acrylate oligomers | 6 |
| photoinitiators | 7 |

### Example 3

| Constituent | Content/[% by weight] |
|---|---|
| difunctional acrylate monomers | 15 |
| monofunctional acrylate monomers | 39 |
| polymethyl urea powder | 15 |
| polyfunctional acrylate monomers | 12 |
| acrylate oligomers | 12 |
| photoinitiators | 7 |

### Example 4

| Constituent | Content/[% by weight] |
|---|---|
| difunctional acrylate monomers | 25 |
| monofunctional acrylate monomers | 20 |
| polymethyl urea powder | 20 |
| polyfunctional acrylate monomers | 14 |
| acrylate oligomers | 14 |
| photoinitiators | 7 |

### Test

### Specimen

In order to produce the specimens, the matte ink is printed on plastic plates. The method according to the present invention is performed with the following parameters:
Printhead: KM1024i LHE
Resolution: 360×360 dpi
Layer thickness: approximately 15 μm
UV radiation sources: IST MBS-5 (270 W/cm) with 600 mJ/cm²

### Degree of Gloss

In order to determine the degree of gloss, a conventional gloss meter (BYK® Gardener of the company BYK®) is used. The gloss is measured at an angle of 60°.

### Visual Examination

The surface has been visually examined by inspection of the specimen under standard light D65 at an angle of 45°. A closed surface is a good result (result: OK).

### Thumb Twist Test

The thumb is pressed against the coated surface and then twisted. An entirely cured coating does not feel tacky and does not show any traces (result: OK).

Table 1 shows the results of the tests.

TABLE 1

| | Degree of Gloss | Visual | Thumb |
|---|---|---|---|
| | [GU at 60°] | Examination | Twist Test |
| Example 1 | 19 | OK | OK |
| Example 2 | 17 | OK | OK |
| Example 3 | 15 | OK | OK |
| Example 4 | 14 | OK | OK |

The present invention is not limited to embodiments described herein; reference should be had to the appended claims.

What is claimed is:

1-13. (canceled)

14. A coating material composition for producing a matte ink, the coating composition comprising:
10 to bis 40 wt. % of at least one difunctional monomer;
20 to 50 wt. % of at least one monofunctional monomer;
5 to 35 wt. % of at least one organic matting agent which is selected from at least one polymethyl urea powder having a particle size of D90<1 μm;
1 to 30 wt. % of at least one acrylate oligomer or at least one polyfunctional acrylate monomer or a mixture of the at least one acrylate oligomer and the at least one polyfunctional acrylate monomer; and
2 to 13 wt. % of at least one photoinitiator,
wherein each wt. % is based on a total weight of the coating material composition.

15. The coating material composition as recited in claim 14, wherein,
the at least one polyurea powder is selected as a matting agent, and
the at least one polyurea powder has a particle size of D90<1 μm.

16. The coating material composition as recited in claim 14, further comprising:
0.1 to 1.3 wt. % of at least one stabilizer based on the total weight of the coating material composition.

17. The coating material composition as recited in claim 16, wherein the at least one stabilizer is selected from methoxyphenol, butylhydroxytoluene, 2,6-bis(1,1-dimethylethyl)-4-(phenylene-methylene)-cyclohexa-2,5-dien-1-one, tris(N-hydroxy-N-nitrosophenylaminato-O,O′)aluminum, and a mixture thereof.

18. The coating material composition as recited in claim 14, further comprising:
0.1 to 1.0 wt. % of at least one levelling agent based on the total weight of the coating material composition.

19. The coating material composition as recited in claim 18, wherein the at least one levelling agent is selected from at least one organically modified silicone.

20. A method of using the coating material composition as recited in claim 14 as a matte ink to produce a matte top coating, the method comprising:
providing the coating material as recited in claim 14; and
using the coating material composition as recited in claim 14 as the matte ink in an inkjet printing process to produce the matte top coating.

21. A coating system comprising:
at least one decorative layer prepared from at least one colored ink; and
at least one top coat layer prepared from at least one matte ink which is produced via the coating material composition as recited in claim 14.

22. The coating system as recited in claim 21, further comprising:
a primer layer.

23. The coating system as recited in claim 21, further comprising:
a layer which is prepared from at least one white ink.

24. A method for producing a matte coating system, the method comprising:
a step (a) of applying at least one colored ink via an inkjet printing method;
a step (b) of pre-gelling of the at least one colored ink which has been applied in the step (a) via a UV irradiation;
a step (c) of applying at least one matte ink which is produced via the coating material composition as recited in claim 14 via an inkjet printing method, so as to obtain an entire layer construction; and
a step (d) of curing the entire layer construction via the UV irradiation.

25. The method as recited in claim 24, further comprising, after the applying of the at least one matte ink which is produced via the coating material composition as recited in claim 14 via the inkjet printing method in the step (c):
a step (c1) of pre-gelling the at least one matte ink via the UV irradiation.

26. The method as recited in claim 24, further comprising, prior to the applying of the at least one matte ink which is produced via the coating material composition as recited in claim 14 via the inkjet printing method in the step (c):
repeating the step (a) and the step (b),
wherein,
at least one white ink is first applied via the step (a) and pre-gelled via the step (b), and
thereafter the at least one colored ink is applied via the step (a) and pre-gelled via the step (b).
